(19) United States
(12) Patent Application Publication
(10) Pub. No.: US 2015/0159684 A1
(43) Pub. Date: Jun. 11, 2015

(54) RELEASABLE MOUNTING SYSTEM FOR LOGISTICS TRACK

(71) Applicant: Ancra International LLC, Azusa, CA (US)

(72) Inventors: Thomas Henry Leone, Burlington, KY (US); Lyle Mark Daugherty, Union, KY (US)

(73) Assignee: Ancra International LLC, Azusa, CA (US)

(21) Appl. No.: 14/453,890

(22) Filed: Aug. 7, 2014

Related U.S. Application Data
(60) Provisional application No. 61/913,896, filed on Dec. 9, 2013.

(51) Int. Cl. F16B 5/02

(52) U.S. Cl. CPC F16B 5/0225

(57) ABSTRACT

A system for removably connecting to a fixed track provided. The system includes an elongate rigid member including a structural frame and an opening disposed within the frame, the opening extending along a portion of a width of the frame, the elongate rigid member further comprising a front surface that defines the opening therein, and a rear surface opposite from the front surface that is planar. An adapter is provided that mates with a rear surface of the rigid member, the adapter further comprising a tooth that defines a void between the tooth and the planar face. The adapter is configured to be received within a first aperture of the plurality of spaced apertures upon the fixed track, such that a portion of the fixed track that defines a lower boundary of the first aperture of the plurality of spaced apertures is received within the void in the adapter.

### CROSS-REFERENCE TO RELATED APPLICATIONS

This application claims priority to U.S. Provisional Application No. 61/913,896, filed on Dec. 9, 2013, the entirety of which is hereby fully incorporated by reference herein.

### TECHNICAL FIELD

This disclosure relates to structures to allow for connection of a releasable track to a fixed track within a cargo storage environment or a transportable cargo container.

### BRIEF SUMMARY

A representative embodiment of the disclosure is provided. The embodiment includes a system for removably connecting to a fixed track aligned with a plurality of spaced apertures aligned along a length of the track. The system includes an elongate rigid member including a structural frame and an opening disposed within the frame, the opening extending along a portion of a width of the frame, the elongate rigid member further comprising a front surface that defines the opening therein, and a rear surface opposite from the front surface that is planar. An adapter is provided that includes a planar face that is configured to mate to and be fixed with the rear surface and extend therefrom, the adapter comprising a rigid body with a width smaller than a width of one of the plurality of spaced apertures on the fixed track, the adapter further comprising a tooth that defines a bottom portion of the adapter, the adapter defines a void between the tooth and the planar face. The adapter is configured to be received within a first aperture of the plurality of spaced apertures upon the fixed track, such that a portion of the fixed track that defines a lower boundary of the first aperture of the plurality of spaced apertures is received within the void in the adapter.

Advantages of the disclosed devices will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a side view of a removable track that is configured to be removably secured to a fixed track within a cargo container.

FIG. 2 is a top view of the track of FIG. 1.

FIG. 3 is a detail view of detail A of FIG. 1, shown in cross-section, with the removable track engaging a fixed track.

FIG. 4 is a rear view of a fixed track showing the fixed track connected thereto.

FIG. 5 is an exploded view of the removable track of FIG. 1.

### DETAILED DESCRIPTION OF THE DRAWINGS AND THE PRESENTLY PREFERRED EMBODIMENTS

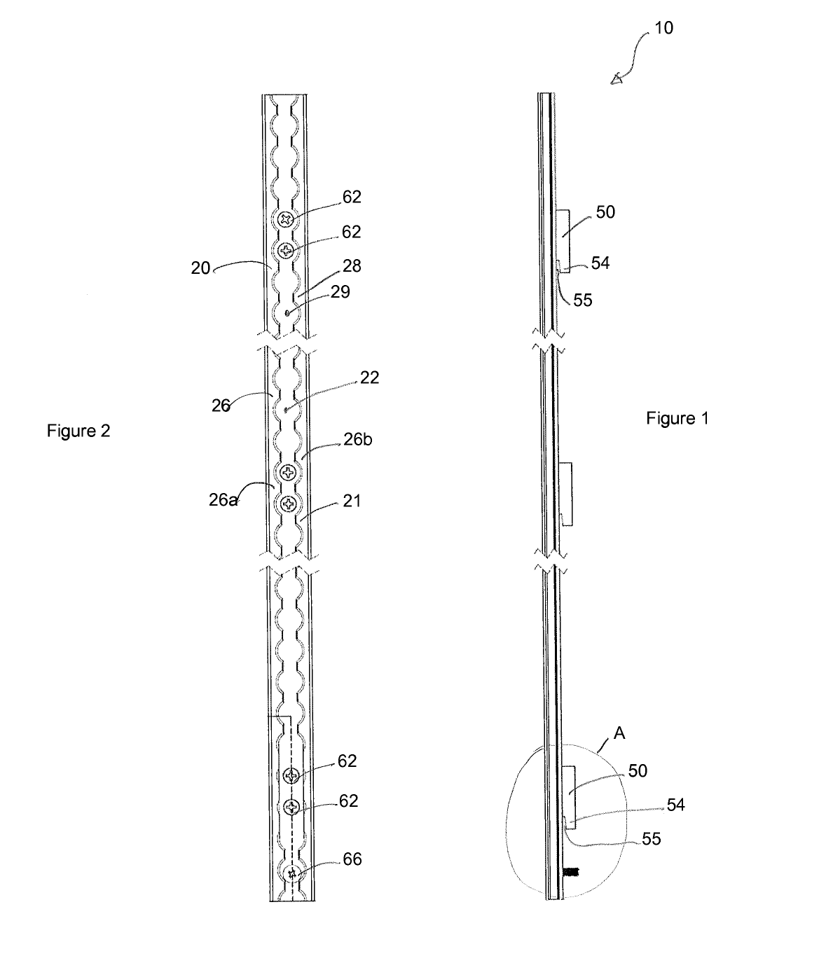

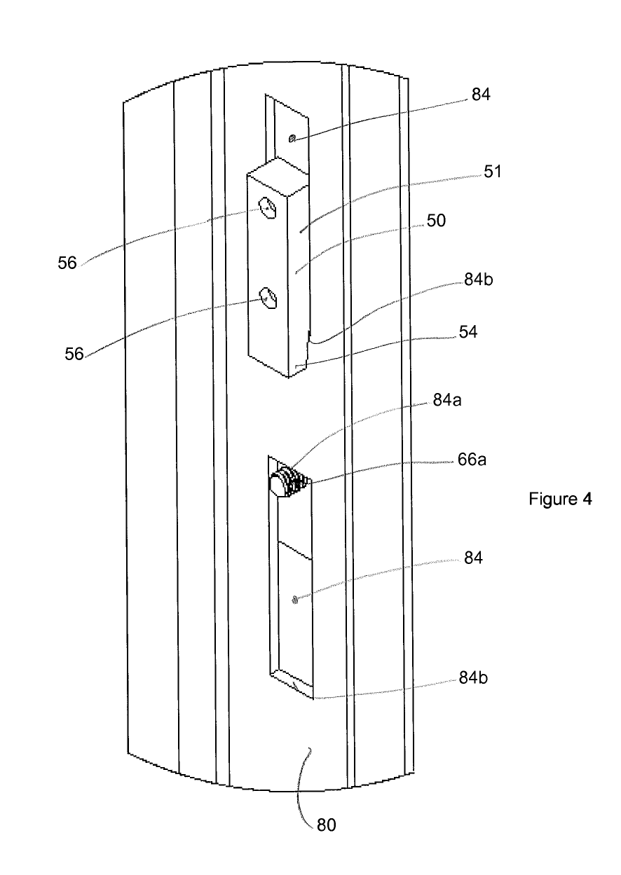

Turning now to FIGS. 1-5, a system 10 for removably connecting an elongate rigid member 20, such as a track, to a fixed logistics track 80 is provided. The fixed track 80 may be one of a plurality of lengths of stationary logistics track, such as “A” or “E” track, which are well known in the art. The logistics track is normally rigidly mounted to the walls or floor of a cargo container, or to a storage facility. In some embodiments, the track 80 comprises a vertically aligned track that is mounted to the walls of the cargo compartment. The track 80 may have a plurality of apertures 84 that are disposed in a spaced relationship along the length of the track 80, such as at equal spacing from each other. In some embodiments the track 80 may be disposed in opposing pairs upon opposite walls of the cargo compartment. In some embodiments, a plurality of tracks 80 may be disposed upon each wall of the cargo compartment to allow for flexibility in the arrangement of the storage equipment therewithin, which is releaseably mounted to the tracks 80 for desired storage and transport purposes. In some embodiments, and as best shown in FIG. 4, the fixed track 80 may include a central portion (the planar portion that includes the plurality of apertures 84 that is set of forward of the opposed sides of the track 80 (which contact the mounting surface) to create a space behind the central portion when the track 80 is mounted to a flat surface.

In some embodiments, a removable track 20 may be individually rigidly mounted to each or one or more of the tracks 80, such that the removable track 20 is disposed to receive fittings or connectors associated with storage equipment for use within the cargo compartment. The removable track 20 may be an elongate rigid member with a structural frame 21 that defines a front surface 26 and a rear surface 32. The rear surface 32 is configured to contact a front surface of the track 80 when mounted thereon. The removable track 20 may include one or two front ledges 26a, 26b that in combination define the front surface 26 of the track 20, with the front ledges 26a, 26b being spaced outwardly from a back 32a of the track 20 to define an internal volume 27 therebetween. In some embodiments, a removable track 20 may be fixed to each of the tracks 80 within the cargo compartment, while in other embodiments, a selective number of removable tracks 20 may be used as needed for the desired storage arrangement.

In some embodiments, the front ledges 26a, 26b may collectively have an undulating pattern that defines an opening that may be formed by a plurality of spaced nodes 29 with a plurality of lugs 28 disposed therebetween along the length of the track 20. The combination of the nodes 28 and ledges 29, and the size and depth of the internal volume 27 may selected to work with external fasteners and receiving structures to allow for releasable engagement with the removable track 20 for storage and cargo control purposes.

The removable track 20 may additionally support a plurality of adapters 50 upon the rear surface 32 of the removable track 20. The plurality of adapters 50 may be disposed upon the rear surface 32 of the track 20 in a spacing relationship along the removable track 20 such that each of the adapters 50 are disposed in alignment with an aperture 84 of the track 80 when the removable track 20 is fixed to the fixed track 80 and specifically, with each adapter 50 being inserted within an aperture 84 in the track 80. The plurality of adapters 50 may be made from a depth such that when the removable track 20 engages the fixed track 80, the adapter is received within the space formed behind the central planar portion of the fixed track 80.

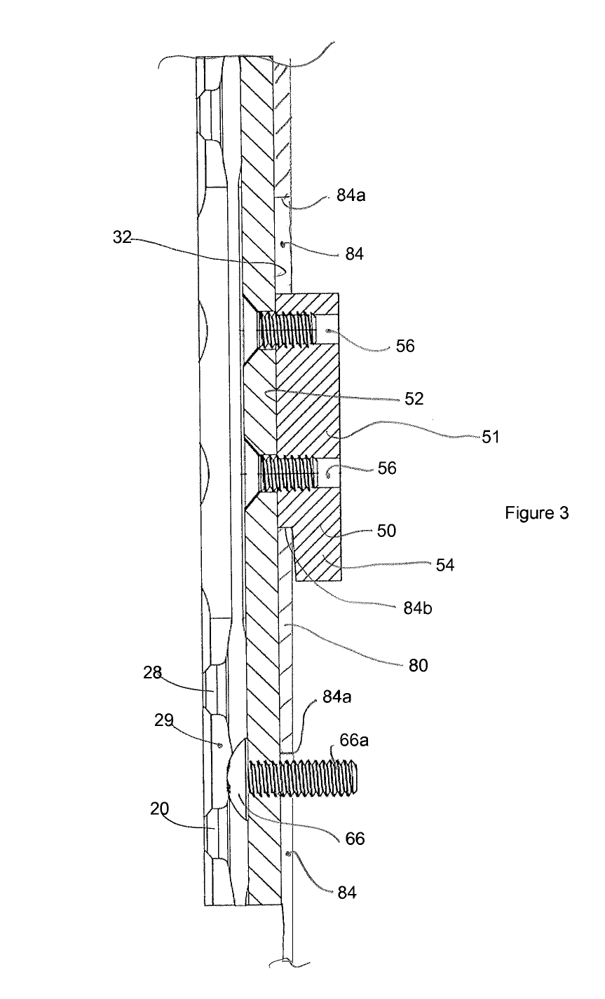

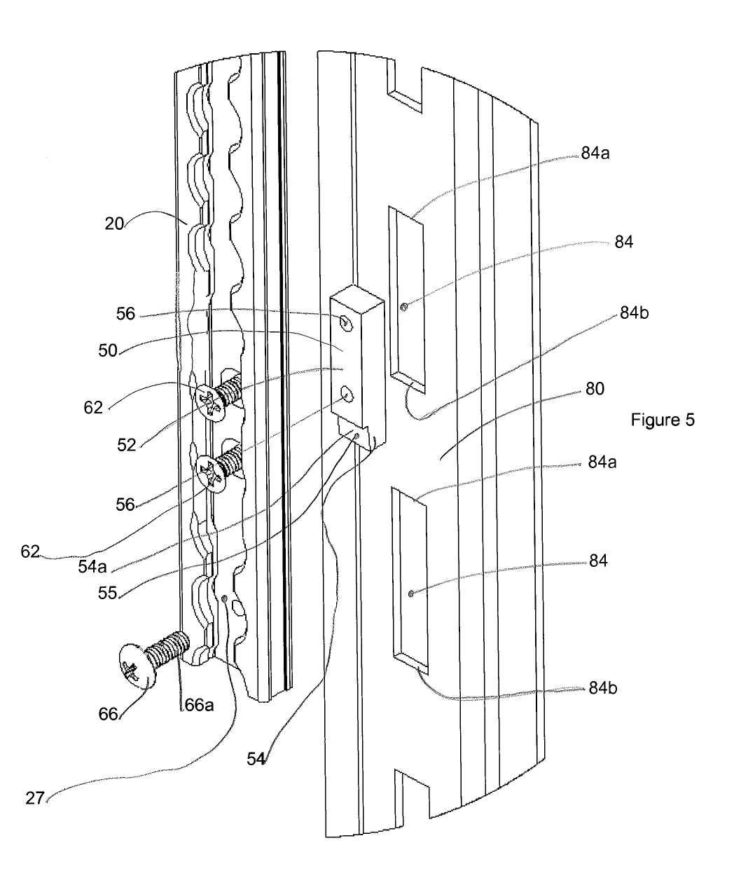

The adapter is best shown in FIGS. 3 and 5 and includes a body 51 and a tooth 54 that extends downwardly from the body 51. The body 51 defines a front surface 52 that contacts the rear surface 32 of the removable track 20 when the adapter is connected to the removable track 20. The tooth 54 is formed with a depth less than the depth of the body 51 and the tooth 54 defines a void 55 between a front surface 54a of the tooth 54 and a plane that extends through the front surface 52 of the body 51. In some embodiments, the void 55 is formed with a depth just larger than a thickness of the material that forms the fixed track 80 (and specifically the thickness of the material forming the portion of the fixed track 80 that defines the plurality of apertures 84).

The body 51 of the adapter 50 may further include two or more holes 56, which may be through holes, or in other embodiments, may be blind holes that extend into the body from the front surface 52 of the adapter 50. In some embodiments the holes 56 may be tapped to receive the threads of a correspondingly threaded fastener 62. The removable track 20 may be formed with a number of apertures that are disposed in position to receive the fastener 62 therethrough to fix the plurality of adapters 50 to the removable track 20. In some embodiments, the apertures in the removable track 20 may be formed with a recess or a ledge that is configured to receive the entire or a portion of the head of the fastener 62 to eliminate or minimize the location of the head of the fastener 62 within the inner volume of the removable track 20 to minimize or eliminate any interference between the fastener with various connectors or other structures that interact with the removable track 20.

As best understood with reference to FIGS. 3 and 4, the adapters 50 are configured to be received through respective apertures 84 in the fixed track 80 when the removable track 20 contacts the fixed track 80. As can be appreciated with reference the figures, the width of the adapters 50 is best made to be just slightly narrower than the width of the aperture 84 (for embodiments where the apertures 84 are rectangular) such that engagement between the adapter 50 and the aperture 84 disposed therethrough provides lateral support for the removable track 20. Similarly, the height of the adapter 50, measured from the top surface of the body 51 to the opposite bottom surface of the tooth 54 must be smaller than the overall height of the aperture 84 to allow the adapter 50 to be inserted through the aperture 84. In some embodiments, the height of the adapter 50 is just smaller than the overall height of the aperture. The adapters 50 are positioned upon the fixed track 80 such that all of the adapters 50 extend through the respective apertures 84 in the fixed track 80 at the same time.

As shown in FIGS. 3 and 4, the tooth 54 (and the void 55 created by the tooth 54) is positioned to contact the surface of the fixed track, with a portion of the fixed track 80 disposed within the void 55 after the adapters 50 extend through the respective apertures 84, and the removable track 20 allowed to slide downward with respect to the fixed track 80 (for a distance equal to the length of the tooth 54). As can be understood with view of FIG. 3, engagement between the lower edge 84b and the bottom surface of the body 51 limits the relative downward motion of the removable track 20 with respect to the fixed track 80.

In some embodiments a second fastener 66 may be provided through the removable track 20, and specifically an aperture in the removable track 20 that is disposed such that a shaft 66a of the second fastener 66 extends through an open aperture 84 within the fixed track 80 (i.e. an aperture 84 that does not receive an adapter 50 therethrough). In some embodiments, the second fastener 66 (and the aperture on the removable track 20 that receives the second fastener 66) is configured to allow the shaft 66a of the second aperture 66 to contact or be just below the upper edge 84a of the respective aperture 84 when the removable track 20 is positioned in the released position, i.e. with the fixed track 80 disposed through the void 55 and the lower edge 84b of the respective apertures 84 in contact with the lower surface of the body 51 of the adapter 50. As can be understood with reference to FIGS. 3 and 4, the position of the second fastener 66 with its shaft 66a in contact with or in close proximity to the upper edge 84a of the respective aperture 84 prevents upward motion of the removable track 20 with respect to the fixed track 80, which prevents relative vertical motion of the removable track 20 with respect to the fixed track 80 and therefore maintains the removable track 20 substantially rigidly mounted upon the fixed track 80 and therefore with respect to the wall of the cargo compartment. As can be understood, with the use of second fastener 66 (in situations where a small distance exists between the shaft 66a of the second fastener 66 and the upper edge 84a of the respective aperture 84, and the closely fitting width of the adapter 50 to the width of the respective aperture 84) eliminates or substantially eliminates any relative motion or play between the fixed and removable tracks 80, 20, while maintaining the connection therebetween with a single second fastener 66 that is easily and conveniently removed if the removable track 20 is desired to be removed from the removable track 20.

A method of releaseably engaging a track 20 to a fixed track, such as a logistics track 80 is provided. The method includes providing a releasable track 20, such as the releasable track 20 with one or more adaptors 50 disposed to a rear surface of the track 20. The adapters 50 may each be fixed to the track 20 with a plurality of fasteners. The method further includes the step of engaging the releasable track 20 with a fixed track 80, such as a conventional logistics “A” or “E” track, which has been previously been rigidly mounted to a wall of a cargo compartment. The fixed track 80 includes a plurality of apertures 84 that are distributed in (preferably in a uniform spacing manner) along the length of the track 80. The removable track 20 approaches the fixed track 80 such that the adaptors 50 extending from the removable track 20 are disposed in alignment with respective apertures 84 from the plurality of apertures 50 and such that the adapters 50 each slide within an aperture 84 in the fixed track 80. The releasable track 80 is then released which allows the releasable track 80 to slide relatively downward with respect to the fixed track 80, until the lower edge 84b of the respective aperture 84 contacts a lower surface of the body 51 of the adapter 50.

A fastener 66 is then engaged through the removable track 20 (through an aperture produced through the rear surface 32 of the frame 21 of the track 20) until the shaft 66a of the fastener 66 extends through an aperture 84 in the fixed track 80. Preferably, the aperture in the removable track 20 is disposed such that the shaft 66a of the fastener 66 is disposed in contact with or in close proximity to the upper edge 84a of the respective aperture 84 to prevent relative upward movement of the removable track 20 with respect to the fixed track 80. When the removable track 20 is desired to be removed, the fastener 66 may be removed, which allows the removable track 20 to be moved upwardly with respect to the fixed track 80, which disengages the fixed track from the void 55 proximate to the tooth, and allows the plurality of adapters 50 to slide out of the respective plurality of apertures.

While the preferred embodiments of the disclosure have been described, it should be understood that the disclosure is not so limited and modifications may be made without departing from the invention. The scope of the invention is defined by the appended claims, and all devices that come within the meaning of the claims, either literally or by equivalence, are intended to be embraced therein.

1. A system for removably connecting to a fixed track aligned with a plurality of spaced apertures aligned along a length of the track, comprising:
an elongate rigid member including a structural frame and an opening disposed within the frame, the opening extending along a portion of a width of the frame, the elongate rigid member further comprising a front surface that defines the opening therein, and a rear surface opposite from the front surface that is planar;
an adapter comprising a planar face that is configured to mate to and be fixed with the rear surface and extend therefrom, the adapter comprising a rigid body with a width smaller than a width of one of the plurality of spaced apertures on the fixed track, the adapter further comprising a tooth that defines a bottom portion of the adapter, the adapter defines a void between the tooth and the planar face,
wherein the adapter is configured to be received within a first aperture of the plurality of spaced apertures upon the fixed track, such that a portion of the fixed track that defines a lower boundary of the first aperture of the plurality of spaced apertures is received within the void in the adapter.

2. The system of claim 1, wherein the surface of the tooth that faces the elongate member contacts the fixed track when the adapter is received within one of the plurality of spaced apertures.

3. The system of claim 1, further comprising a fastener that is configured to extend through the structural frame of the rigid member and into an upper portion of a second aperture of the plurality of apertures, wherein the insertion of the fastener into the upper portion of the second aperture prevents the elongate rigid member from being translated vertically with respect to the fixed track.

4. The system of claim 1, wherein the two or more adapters are spacingly mated to and fixed with the rear surface of the rigid member, wherein each of the two or more adapters are spaced along the rigid member such that each adapter is configured to be received within a respective one of the plurality of spaced apertures upon the fixed track.

5. The system of claim 1, wherein the adapter is rigidly fixed to the frame with one or more fasteners.

6. The system of claim 5, wherein the opening in the elongate rigid member comprises a plurality of node segments and a plurality of lug segments disposed between adjacent node segments, wherein the one or more fasteners are disposed in alignment with one or more node segments of the plurality of node segments.

7. The system of claim 3, wherein the opening in the elongate rigid member comprises a plurality of node segments and plurality of lug segments disposed between adjacent node segments, wherein the fastener is disposed in alignment with one of the plurality of node segments.
